(19) United States
(12) Patent Application Publication
(10) Pub. No.: US 2014/0039949 A1
(43) Pub. Date: Feb. 6, 2014

(54) DETERMINING SUPPLIER ENVIRONMENTAL IMPACT

(71) Applicants: Kiara Groves Corrigan, Burlingame, CA (US); Amip J. Shah, Santa Clara, CA (US)

(72) Inventors: Kiara Groves Corrigan, Burlingame, CA (US); Amip J. Shah, Santa Clara, CA (US)

(21) Appl. No.: 13/562,735

(22) Filed: Jul. 31, 2012

(51) Int. Cl. G06Q 10/06

(52) U.S. Cl. 705/7.11

(57) ABSTRACT

A computer-implemented method for determining supplier environmental impact (EI) can include identifying a number of tiers of suppliers for an activity of an entity, mapping the activity of the entity to an economic sector and an environmental sector using data accessed from a public database, and determining an EI for each supplier in the number of tiers of suppliers for the activity based on data associated with the mapped economic sector and the mapped environmental sector, wherein the method is performed by a computing device.

### BACKGROUND

Organizations are increasingly expected to provide data representing their environmental footprint to satisfy consumer expectations and governmental regulations. Data representing an environmental footprint can include information about energy use, carbon dioxide emissions, water use, and pollution production, among other environmental information.

### BRIEF DESCRIPTION OF THE DRAWINGS

FIG. 1 is a block diagram illustrating an example of a method for determining supplier environmental impact according to the present disclosure.

FIG. 2 is a flow chart illustrating an example process for determining supplier environmental impact according to the present disclosure.

FIG. 3 is a block diagram illustrating a processing resource, a memory resource, and a computer-readable medium according to the present disclosure.

### DETAILED DESCRIPTION

Determining an environmental impact of a particular entity, such as a company, school district, city, or business entity, can involve large amounts of resources devoted to manually collecting data about the environmental impact of each of the entity's activities. Measuring the environmental impact of a particular entity can involve manually tracking the entity's supply chain and collecting detailed environmental impact data related to each portion of the supply chain. Entities are increasingly interested in managing cost related to governmental environmental regulations, as well as, satisfying consumer expectations relating to the entity's environmental impact. An entity may desire to look beyond the entity's internal (e.g., operational) environmental impact and manage the environmental impact of the entity's supply chain.

Determining an environmental impact of an entity's supply chain can involve collection of a large amount of data about the environmental impact of each of the suppliers. An entity may have limited insight into each of the supplier's environmental performance. Further, an entity may have numerous suppliers, and each supplier may have numerous suppliers (e.g., intermediary suppliers). Estimating an environmental impact of specific set(s) of suppliers (e.g., subset of suppliers) can involve collecting large amounts of data and result in an inaccurate estimate due to an inability to collect the necessary data. For instance, an entity may have little ability to collect data from a supplier of a supplier.

Determining supplier environmental impact (EI), in accordance with various examples of the present disclosure, can include estimating a tier-by-tier EI of an entity's supply chain from the entity's tier 1 to tier k suppliers using environmental data and economic data accessed from a public database. Estimating a tier-based EI of suppliers of an entity can assist an entity in identifying a tier of suppliers that has a higher EI than other tiers, referred to as an EI hotspot. An entity can use identified EI hotspots to target problem areas in their supply chain, such as problem tiers, problem suppliers, and/or specific EIs (e.g., high water use).

For example, the environmental data can include aggregate EI information related to the impact of an activity as performed by a number of entities. Using the environmental data to estimate a supply chain impact can allow for estimating the EI of the suppliers without collecting environmental, purchasing, and/or cost data specifically related to EIs of each supplier. The environmental data may be determined, for example, from a model reflecting EI in terms of an economic variable, such as EI per dollar or unit of output and/or inputs.

Further, in accordance with various examples of the present disclosure, determining supplier EI can include determining a final demand output for an activity of an entity. For instance, a final demand output can include estimated sales of an activity to final markets (e.g., consumers). Estimating the final demand output can increase the accuracy of a supply chain impact estimate. For example, determining EI of suppliers without considering the final demand output can result in overestimation of supply chain EI by assuming total output produced is sold to final markets.

Examples of the present disclosure include methods, system, and computer-readable medium storing a set of instructions to determine a supplier environmental impact (EI). A computer-implemented method for determining supplier EI of an entity can include identifying a number of tiers of suppliers for an activity of the entity, mapping the activity of the entity to an economic sector and an environmental sector using data accessed from a public database, and determining an EI for each supplier in the number of tiers of suppliers for the activity based on data associated with the mapped economic sector and mapped environmental sector.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit or digits correspond to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Also, as used herein, “a number of” an element and/or feature can refer to one or more of such elements and/or features.

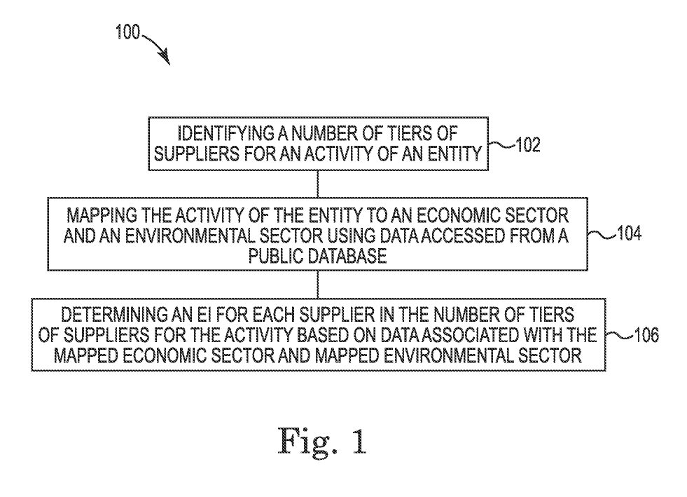

FIG. 1 is a block diagram illustrating an example of a method 100 for determining EI of suppliers according to the present disclosure. The method 100 can be used to determine a tier-based EI of a subset of suppliers of an entity. For instance, the method 100 can include a tier-by-tier estimation of EI of an entity's supply chain from the entity's tier 1 to tier 2 to tier k suppliers. The method 100 can include a computer implemented method and can be performed by a computing device, for instance.

At 102, a number of tiers of suppliers for an activity of an entity can be identified. An entity can include a business, a company, an organization, and a school district, among many other entities. For instance, an entity can include a sub-entity of an entity (e.g. a business unit of an entity, a branch of an entity, a geographic unit of an entity). A supplier, for instance, can include a separate entity that provides a supply to the entity. A supply can include a material, natural resource, a component, and/or other supply items that are involved in moving a product and/or service from a source (e.g., an entity) to other entities (e.g., inter-industry) and/or to a customer (e.g., final demand customer).

For instance, an entity can have a supply chain of suppliers. A supply chain can include the total number of suppliers that supply products to the entity. A supply chain can include a number of entities and/or organizations directly linked by one or more upstream and/or downstream flows of products, services, finances, and/or information from a source (e.g., the entity) to a customer. For instance, downstream can include an entity's customers and/or intermediaries and upstream can include an entity's supplier and/or intermediaries.

A total supply chain of an entity can include many tiers of suppliers (e.g., a plurality of tiers of suppliers). For instance, each tier of suppliers can represent a degree of separation of suppliers from an entity. A degree of separation of suppliers from an entity can include a contact with the entity. For instance, a first tier can include a first degree of separation. A first degree of separation can include a direct contact with the entity. Thereby, a first tier can include direct suppliers of the entity. A direct supplier, for instance, can directly provide a supply to the entity. A second tier can include a second degree of separation. A second degree of separation can include a direct contact with a first tier supplier. Thereby, a second tier can include direct suppliers of a first tier supplier. A second tier supplier can include an intermediary supplier of the entity. The tiers of suppliers can include a kth tier representing a kth degree of separation from the entity. A kth tier can include a desired tier, for instance. The total supply chain can include economy-wide suppliers (e.g., n tiers).

A number of tiers of suppliers can, for instance, include a subset of suppliers of a total supply chain. For example, a subset of suppliers of a total supply chain can include a number of tiers of suppliers selected for an EI analysis (e.g., kth tier). The subset can be selected and/or determined by an input of a user, for example. A user can include a person associated with the entity and/or a third-party, for instance.

An activity, for instance, can include a suitable activity related to the entity, such as producing a product, providing a service, or performing a support function. In some examples of the present disclosure, activities of an entity can be separated by sub-entities (e.g., business units) of an entity.

At 104, the activity of the entity can be mapped to an economic sector and an environmental sector using data accessed from a public database. An economic sector can include a sector of the economy. For instance, an economic sector can include an Economic Input Output (EIO) sector. An EIO sector can include a sector of the economy as defined by a public database. An activity, for instance, can be associated with a number of economic sectors.

A public database, as used herein, can include an organized collection of data that is available to the public. For instance, a public database can be available to the public on the Internet. A public database can include an environmental database, an economic database, and/or a database associated with an Economic Input-Output Lifecycle Model (EIO-LCA). In accordance with some examples of the present disclosure, the method 100 can include retrieving the data from the public database. For instance, the data can be retrieved and/or accessed automatically. The data accessed can include publically available environmental data and economic data, for instance.

An environmental sector can include an EI sector. An EI sector can include a number of impacts to the environment, such as water usage, pollution, greenhouse gas emissions, and energy use, among other impacts to the environment. For instance, an EIO sector can include an economic sector that is mapped to a number of environmental sectors.

In some examples of the present disclosure, an output of the activity can be mapped to the economic sector and the environmental sector. An output of an activity can include an economic outcome of the activity for the entity. An output of an activity, for instance, can include a unit of production of the activity, sales of the activity, profit of the activity, expense of the activity, revenue of the activity, for instance. For example, an output of an activity can require a number of inputs (e.g., supply) to produce the output. The output, for instance, can be used as an input (e.g, economic input) to a model that along with environmental mapping can generate an EI for the supplier (e.g., the EIO-LCA framework).

The economic sector can be associated with data (e.g., economic data) and the environmental sector can be associated with data (e.g., environmental data). Economic data, for instance, can include data such as gross domestic product, and the suppliers in the supply chain's production may be included in the gross domestic production. Environmental data, for example, can include any suitable environmental data and/or information. For example, environmental data can indicate water use, electricity use, greenhouse gas emissions, and/or pollutions. The environmental data can include environmental information about an aggregate EI of an activity in a particular country and/or economy.

Environmental data, for instance, can be related to the impact of an activity as performed by a number of entities. For instance, the number of entities can include the entity and/or at least one similar entity. EI information about an aggregate EI of an activity can include EI data related to a supplier among the supply chain and/or may not include EI information related to all suppliers among the supply chain. For instance, the aggregate EI of an activity may include data related to a supplier even though the EI of the supplier is not specifically measured based on associated economic data (e.g., gross domestic production).

The environmental data may be related to an economic variable. For example, the environmental data may be provided for EI per dollar spent or received. The environmental data may reflect an EI per item produced or dollar sold.

In some examples of the present disclosure, the economic data and/or environmental data can be related to an economic environmental model, such as an EI assessment of the interdependency of an economy, industry, or economic sector. For example, the environmental data can be calculated based on an EIO-LCA Model. The environmental data can describe the EI in any suitable terms, such as impact per unit of productions, sales, purchasing price, expense, profit, revenue, and/or other terms.

At 106, an EI for each supplier in the number of tiers of suppliers can be determined based on data associated with the mapped economic sector and mapped environmental sector. The data can include environmental data and economic data accessed from a public database. For instance, the EI for each of the suppliers can be determined without any additional data inputs besides the environmental data and economic data associated with the supplier. Environmental data can include publically published data and/or data from environmental databases, for instance.

For example, an EI for a supplier in the number of tiers of suppliers can be determined based on the environmental data by comparing the environmental data to an output of an activity of the entity. The output of the activity, for instance, can be based on financial information related to an entity associated with the activity. The financial information may be suitable financial information, such as information about production, sales, revenue, profits, or cost. The output of the activity and/or financial information can be received and/or input from storage and/or by an end user. For example, the method 100 can include retrieving environmental data and/or output data of an activity from storage (e.g., a memory).

In some examples of the present disclosure, determining an EI for a supplier in the number of tiers of suppliers (e.g., subset suppliers of a total supply chain) can include estimating a final demand output for the activity of the entity. A final demand output of the activity of the entity can include an estimate of sales to final markets based on an economically defined relationship between inputs and outputs (e.g., matrix A). Final demand output of an activity can be defined by output that is not sold to other industries as an input (e.g., total output sold to final markets). For instance, a final demand output can be calculated using the example equation:

X=[I−A]⁻¹Y (1)

Wherein Y can denote a final demand output vector for an entity in equation (1). X can denote an economic output vector. A can denote a matrix containing technical coefficients dealing with inputs (e.g., supply) required to produce a desired output, and [I−A]⁻¹ can include a Leontief inverse. Matrix A can, for instance, account for inter-industry sales. For example, matrix A can include an input-output transaction matrix characterizing sector-by-sector input purchases using economically defined sector averages. Thereby, matrix A can characterize each economic sector's supply chain purchases required to produce the output X. In accordance with examples of the present disclosure, the economic output of an economic sector x can be input from public databases.

An EI of suppliers in the number of tiers of suppliers, for example, can be determined using the final demand output. For example, input/supply chain purchases by the entity (e.g., entity, sub-entity, and number of sub-entities) can be correlated to a number of impacts (e.g., environmental sectors) using environmental data to calculate an EI by sector and tier. A number of impacts can include a number of EIs, such as, water use, energy use, greenhouse gas emissions, and pollution, among other impacts.

For instance, a vector of direct environmental outputs can be obtained by multiplying the economic output of an economic sector x by the EI per dollar of an output. The EI per dollar of an output can be obtained from the environmental data (e.g., data associated with a mapped environmental sector). The economic output of an economic sector x can be obtained from data associated with the economic sector x (e.g., data associated with a mapped economic sector). The economic sector x of an output of an activity can be determined by mapping the output of the activity to an economic sector x. In some examples, an activity can be mapped to a number of economic sectors.

For instance, a vector of direct environmental outputs can be defined as:

b=Rx. (2)

Wherein b can denote a vector of EIs (e.g., impacts per dollar of an output multiplied by the output for each impact) for each economic sector. An EI can include water use, electricity use, greenhouse gas emissions, pollutions, and/or other impacts, for example. Wherein x can denote an economic output for an economic sector, and R can denote a matrix with diagonal elements representing the impact of output. Direct and indirect EI can include a total EI of an entity. A total EI of an entity can be defined as:

B=RX (3)

Combining equation (1) with equation (2) can result in:

B=R(I−A)⁻¹Y. (4)

For instance, determining an EI for each of the number of tiers of suppliers for the activity based on the environmental data and the economic data can include using equation (4) in a tier-by-tier analysis. For example, a calculation in a tier-by-tier analysis can include:
1st tier: B₁=RAY
2nd tier: B₂=RA²Y
k^{th} tier: Bₖ=RA^{k}Y
n^{th} tier: Bₙ=RAⁿY

In accordance with some examples of the present disclosure, equation (4) can be used to determine an EI (e.g., B) across a number of sub-entities of an entity and tier k for a number of economic sectors associated with the sub-entities.

In various examples of the present disclosure, a tier-based EI of suppliers for the activity of the entity can be determined based on the number of EIs for each of the suppliers in the number of tiers of suppliers. For example, a tier-based EI of suppliers can be determined by calculating a sum of the determined EIs for each of the suppliers in the number of tiers of suppliers (e.g., subset of suppliers in tier k). The tier-based EI determined can include a tier-by-tier analysis of the EIs of the subset of suppliers (e.g., tier k).

The tier-based EI of the suppliers can, in various examples of the present disclosure, be determined across a number of EIs. The number of EIs can include a number of environmental sectors. An environmental sector can include, for instance, a number of impacts such as water use, greenhouse gas emissions, pollution, and energy use, among other impacts.

In some examples, the method 100 can include calculating a total tier-based EI of suppliers for a number of activities and/or for a number of sub-entities of an entity for a desired tier (e.g., tier k). A total tier-based EI of suppliers can include indirect supplier EI for a number of activities and/or for a number of sub-entities for a desired tier, for instance. Thereby, an entity can determine a total tier-based EI of suppliers across all activities of the entity for a desired tier (e.g., tier k) and/or the number of tiers of suppliers of an entity.

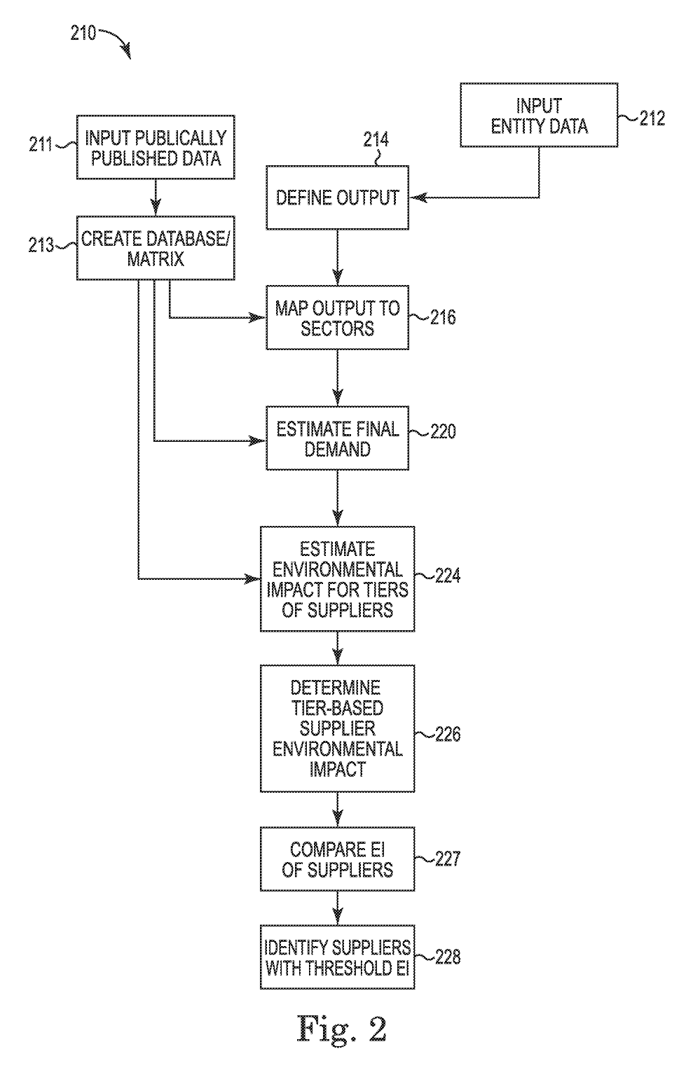

FIG. 2 is a flow chart illustrating an example process 210 for determining supplier EI according to the present disclosure.

At 211, publically published data (e.g., public data) can be accessed, input, and/or retrieved. For example, the data can be automatically accessed, input and/or retrieved. The publically published data can include environmental data and economic data accessed from a public database. For instance, the publically published data can include EIO-LCA data. The publically published data, at 213, can be used to setup and/or create a database and/or matrix. For instance, the data can be mapped to a database and/or matrix. A database and/or matrix can include an environmental and/or economic database and/or matrix, for instance.

At 214, an output of an activity can be defined. For example, the output of the activity can be defined based on entity data. The entity data, for instance, can be input 212 by a user and/or be located in storage (e.g., memory). The entity data, for example, can include a number of defined outputs of a number of activities of the entity. For example, the number of activities can be associated with a number of sub-entities of the entity and/or the entity as a whole.

At 216, an output of an activity for the entity can be mapped to a number of economic sectors and environmental sectors using the data accessed from the public database. For instance, an output of an activity can be associated with one and/or a plurality of economic sectors and one and/or a plurality of environmental sectors. Each economic sector and environmental sector, for instance, can be associated with data accessed and/or input from public databases, setup databases and/or matrices.

In some examples of the present disclosure, a number of outputs of a number of activities for an entity can be mapped to a number of economic sectors and a number of environmental sectors. For instance, the number of activities can be associated with a number of sub-entities (e.g., business units, geographic units, economic units) of an entity.

At 220, a final demand output for the activity of the entity can be estimated using data associated with the mapped economic sectors. For instance, estimating final demand can include inputting a matrix 213 of economic sector (e.g., EIO sector) input purchases using economically defined economic sector averages. The matrix can contain technical coefficients dealing with inputs required to produce a desired output. The matrix, for instance, can include matrix A from equation (1).

At 224, an EI for each supplier of a number of tiers of suppliers of the activity can be estimated based on the final demand output determined (e.g., at 220) and environmental data. The environmental data, for instance, can include input and/or accessed publically published data 211 (e.g. accessed from a public database) and can be associated with the mapped environmental sector and/or mapped economic sector.

At 226, a tier-based EI of the number of tiers of suppliers of the activity for the entity can be determined based on the number of EIs of the suppliers. For instance, the tier-based EI of the number of suppliers can be determined by calculating a sum of the number of EIs for each supplier in the number of tiers of suppliers for a specific environmental sector.

In various examples, the tier-based EI of the number of tiers of suppliers can be categorized and/or organized by economic sector, environmental sector, and/or tier. For instance, an output (e.g., final demand output) can be mapped to a number of economic sectors and environmental sectors. The tier-based EIs of the number of tiers of suppliers can be determined based on a sum of the EIs across the number of economic sectors and environmental sectors associated with the output for the respective tier. Thereby, a user can analyze a supply chain of an entity for EI hotspots in the entity's supply chain based on economic sector, environmental sector (e.g., specific impact), tier, and/or any combination thereof. A user, for instance, can include a person associated with the entity and/or a third-party.

In some examples, the process 210 can include estimating a specific EI for each of a number of tiers of suppliers for a number of activities of a number of sub-entities of an entity (e.g., an entity that consist of sub-entities, such as business units). For example, estimating and/or determining a desired tier (e.g., tier k) EI of suppliers of an entity can include calculating a sum of the number of EIs for tier k in each of the number of activities of the number of sub-entities for a specific environmental sector (e.g., a specific impact to the environment).

In various examples of the present disclosure, the process 210 can include calculating a total EI of the entity based on a total tier-by-tier EI of suppliers (e.g., tier-based EI of the number of tiers suppliers) of the entity and a calculated EI of operations of the entity. A total tier-by-tier EI of suppliers can be calculated by summing the EI of a supply chain of suppliers across the number of tiers. For instance, decomposing equation (4) can result in individual terms of a power series approximated which can represent the magnitude of a tier-by-tier EI effect. Decomposing equation (4), for example, can include the equations:

$$\begin{matrix}B = R ( Y + AY + {A}^{2} Y + … ) \\ = RY + RAY + {RA}^{2} Y + … )\end{matrix}$$

Production of output X can occur in-house PS (e.g., in-house of the entity) and can be outsourced OS (e.g., by suppliers). For example, in-house output PS and outsourced output OS can be defined and/or estimated as percentages such as:

I=PS+OS. (5)

Wherein PS can denote a share of total production that occurs in-house, OS can denote a share of total production that is outsourced, and I can denote an identity matrix. For example, PS can include a matrix, such as:

$$PS = \begin{matrix}{PS}_{1} & 0 & 0 & 0 \\ 0 & {PS}_{2} & 0 & 0 \\ 0 & 0 & … & 0 \\ 0 & 0 & 0 & {PS}_{n}\end{matrix}$$

Rewriting equation (3) of B=RX gives

$$\begin{matrix}B = R ( PS + OS ) X \\ = R ( PS ) + R ( OS ) X \\ = R ( PS ) X + ( I - PS ) X\end{matrix}$$

From equation (4), a total EI can be calculated. For example:

$$\begin{matrix}B = RY + RAY + {RA}^{2} Y \\ = R ( PS + OS ) Y + RAY + … \\ = R ( PS ) Y + R ( OS ) Y + RAY + … \\ = R ( PS ) ( X - AX ) + R ( OS ) Y + RAY + … \\ = R ( PS ) X - R ( PS ) AX + R ( OS ) Y + RAY + … \\ = R ( PS ) X - R ( PS ) AX + R ( OS ) ( 1 - A ) X + RAY + … \\ = R ( PS ) X - R ( PS ) AX + R ( OS ) X - R ( OS ) AX + RAY + … \\ = R ( PS ) X + R ( OS ) X - ( R ( PS ) AX + R ( OS ) AX ) + RAY + … \\ = R ( PS ) X + R ( OS ) X - RAY + RAY + …\end{matrix}$$

For example, for a first tier, one round of inter-industry transactions can be used. Estimating and/or determining a total EI including a first tier of suppliers can include:

=R(PS)X+R(I−PS)X−RAX+RAY. (6)

Wherein R(PS)X can denote in-house EI, R(I−PS)X can denote outsourced production, RAX can include an adjustment to avoid double counting of outsourced production, and RAY can denote tier 1 suppliers outside sector. Thereby, equation (6) can include a calculation of the EI of direct production including tier 1 suppliers.

For a second tier, two rounds of inter-industry transaction can be used. For instance:

=R(PS)X+R(I−PS)X−RAX+RAY+RA²Y.

An example equation to calculate a EI of direct company (e.g., the entity) and tier 1 suppliers can include:

Bᵢ=RᵢPSᵢXᵢ+Rᵢ(I−PSᵢ)Xᵢ−RAXᵢ+RAYᵢ. (7)

Wherein i can denote an environmental sector. For instance, an EI of the entity (e.g., direct company) and tier 1 suppliers can be calculated for a number of environmental sectors i.

For instance, equation (6) can be used to determine and/or identify economic sectors and/or tiers of suppliers across an entity that have a higher EI than other economic sectors and/or tiers of suppliers. An entity can determine areas of improvement within the entity's supply chain with regard to the entity's EI.

The determined EI of the number of tiers of suppliers (e.g., subset), in accordance with examples of the present disclosure, can be determined using entity data inputs of X and PS, and publically available data of R and A (e.g., data accessed from a public database).

At 227, in accordance with various examples of the present disclosure, the estimated EIs of each supplier in the number of tiers of suppliers can be compared. Based on the comparison, at 228, a number of suppliers in the number of tiers can be identified. The identified number of suppliers can include suppliers with a threshold EI. A threshold EI can include a predetermined value and/or can include an EI that is higher than EIs of the remaining suppliers in the subset and/or is higher than the EI of the entity.

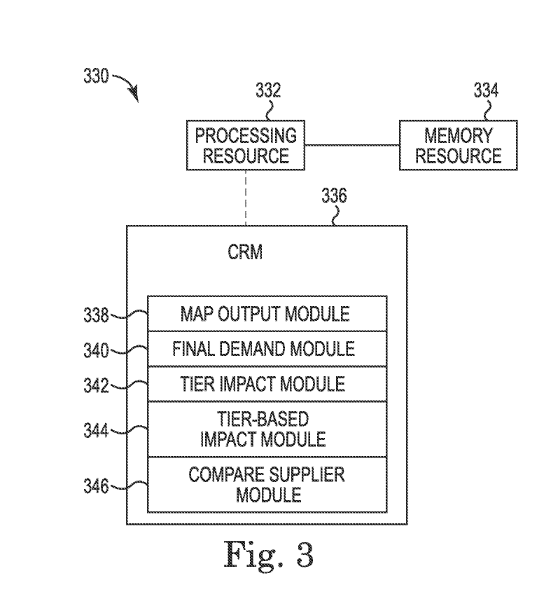

FIG. 3 is a block diagram 330 illustrating a processing resource 332, a memory resource 334, and a computer-readable medium 336 according to the present disclosure. The processing resource 332 and the memory resource 334 can be local to a computing device, such as on a router, switch, server, or other network device, etc. The computer-readable medium (CRM) 336 (e.g., a tangible, non-transitory medium) and/or the memory resource 334 can store a set of instructions executable by the processing resource 332. The CRM 336 can be local to a computing device or remote therefrom. For those examples in which the CRM 336 is remote from the computing device, the instructions can be loaded into the memory resource 334 of the computing device.

As used herein, a processing resource 332 can include one or a plurality of processors such as in a parallel processing system. A memory resource 334 can include memory addressable by the processing resource 332 for execution of computer readable instructions (e.g., program instructions). The memory resource 334 can include volatile and/or non-volatile memory such as random access memory (RAM), static random access memory (SRAM), electronically erasable programmable read-only memory (EEPROM), magnetic memory such as a hard disk, floppy disk, and/or tape memory, a solid state drive (SSD), flash memory, phase change memory, etc. The CRM 336 can also be stored in remote memory managed by a server and represent an installation package that can be downloaded, installed, and executed.

As shown in the example of FIG. 3, the CRM 336 can include a number of modules 338, 340, 342, 344, and 346. The number of modules can include a map output module 338, a final demand output module 340, a tier impact module 342, a tier-based impact module 344, and a compare supplier module 346. The number of modules 338, 340, 342, 344, and 346 can include program instructions to perform particular acts, task, and/or functions as described herein when executed by the processing resource 332.

The number of modules 338, 340, 342, 344, and 346 can be modules and/or sub-modules of other modules. For example, the map output module 338 and the final demand out module 340 can be sub-modules and/or contained within the tier impact module 342. Examples of the present disclosure are not limited to these examples and the number of modules 338, 340, 342, 344, and 346 can be individual modules separate and distinct from one another.

By way of illustration and not by way of limitation, the map output module 338 can include a number of instructions (e.g., a number of CRI) that can be executed by the processing resource 332 to perform or achieve the particular act or carry out the act of mapping an output of an activity for each of a number of sub-entities of the entity to a number of economic sectors and a number of environmental sectors using data accessed from a public database. The number of economic sectors and the number of environment sectors can include EIO sectors, for instance. The data can, for instance, be automatically accessed and/or retrieved from a public database.

The final demand output module 340 can include a number of instructions that can be executed by the processing resource 332. For example, a final demand output module 340 can estimate a final demand output for each activity of the number of sub-entities based on data associated with the number of mapped economic sectors.

The tier impact module 342 can include a number of instructions that can be executed by the processing resource 332. For example, the tier impact module 342 can estimate an EI for each supplier in the number of tiers of suppliers for each activity of the number of sub-entities of the entity based on the estimated final demand outputs and data associated with the number of mapped environmental sectors. The estimated EIs can be categorized and/or organized based on economic sector, environmental sector and/or and tiers.

The tier-based impact module 344 can include a number of instructions that can be executed by the processing resource 332. For example, the tier-based impact module 344 can determine a tier-based EI of the number of tiers of suppliers of the entity based on the number of EIs of each supplier in the number of tiers of suppliers (e.g., subset suppliers) for each activity of the number of sub-entities of the entity. For instance, the determination can include calculating the sum of each estimated EI for each supplier and/or for all tiers for each of the number of activities of the number of sub-entities of the entity.

The compare supplier EI module 346 can include a number of instructions that can be executed by the processing resource 332. For example, the compare supplier EI module 346 can compare the EIs of suppliers in the number of tiers of suppliers for each activity of the number of sub-entities to identify suppliers with a threshold EI. Suppliers with a threshold EI can indicate problem EI areas in the entity's supply chain (e.g., EI hotspots). An entity can analyze EIs of the entity's supply chain for EI hotspot tiers, EI hotspot suppliers within a specific tier, and/or specific EI hotspots (e.g., high impact in an environmental sector across an entire tier). The comparison can be across the number of tiers (e.g. subset suppliers) and/or across each specific tier by comparing individual suppliers.

In some examples of the present disclosure, a number of tiers of suppliers for each activity of the number of sub-entities can be identified. The number of tiers of suppliers, for instance, can include a subset number of suppliers among a total supply chain. The subset number can include a desired tier (e.g. tier k) of suppliers input by a user for an EI analysis.

In various examples of the present disclosure, the processing resource 332 can collect and aggregate the environmental data and economic data. For instance, collecting the environmental data and economic data can include accessing a public database and/or inputting publically published data. The public database can be, for instance, automatically accessed and the data can be automatically retrieved from the public database accessed. The processing resource 332 may retrieve the accessed environmental data and/or economic data from storage (e.g., memory) and/or from an application. The storage can store aggregated environmental/economic data related to a plurality of activities, and the processing resource 332 can select environmental data related to an activity being evaluated. The environmental and economic data may be aggregated across any suitable group of entities. For example, the data may be related to an EI by a region, industry, or sector.

In some examples of the present disclosure, the memory resource 334 can be configured to direct the processing resource 332 to provide an image of the determined tier-based EI of suppliers on a display. The display can include a computing device display screen. A computing device can include a computer, a mobile telephone, a tablet, and a projector, among many other computing devices. A display screen can include a touch screen, an liquid crystal display (LCD) screen, and an organic light-emitting diode (OLED) screen, among other display screens. For example, the display can be communicatively connected to the processing resource 332. The connection can include a direct connection and/or a network connection, for instance.

The image display, in some examples of the present disclosure, can include a tier specific EI display (e.g., tier-by-tier), a sub-entity specific EI display, a tier specific EI by economic sector display, a tier specific EI by economic sector and sub-entity of the entity EI display, and/or any combination thereof. For instance, in response to user indication (e.g. input), an image of the tier-based EI of suppliers categorized by tier and by economic sector can be provided on the display.

The methods, techniques, systems, and apparatuses described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

Although specific examples have been illustrated and described herein, those of ordinary skill in the art will appreciate that an arrangement calculated to achieve the same results can be substituted for the specific examples shown. This disclosure is intended to cover adaptations or variations of one or more examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the one or more examples of the present disclosure includes other applications in which the above structures and methods are used. Therefore, the scope of one or more examples of the present disclosure should be determined with reference to the appended claims, along with the full range of equivalents to which such claims are entitled.

1. A computer-implemented method for determining supplier environmental impact (EI) comprising:
identifying a number of tiers of suppliers for an activity of an entity;
mapping the activity of the entity to an economic sector and an environmental sector using data accessed from a public database;
determining a final demand output for the activity of the entity using data associated with the mapped economic sector, wherein the final demand output of the activity includes an estimate of sales to final markets; and
determining an EI for each supplier in each of the number of tiers of suppliers for the activity of the entity based on the determined final demand output of the activity of the entity and data associated with the mapped environmental sector.

2. The computer-implemented method of claim 1, wherein the entity includes a sub-entity of an entity.

3. The computer-implemented method of claim 1, further including determining a tier-based EI of suppliers for the activity of the entity based on the number of EIs of each supplier in each of the number of tiers of suppliers.

4. The computer-implemented method of claim 1, wherein identifying the number of tiers of suppliers further includes identifying a subset of a supply chain of the entity.

5. The computer-implemented method of claim 1, wherein determining the final demand output includes estimating a sub-portion of output of the activity that is not sold as an input.

6. The computer-implemented method of claim 1, wherein the data accessed from the public database includes publically available environmental data and economic data.

7. The computer-implemented method of claim 1, wherein the data accessed from the public database includes environmental information indicative of an aggregate EI of an activity performed by a number of entities.

8. The computer-implemented method of claim 1, further including automatically accessing the public database to retrieve publically available environmental data and economic data.

9. The computer-implemented method of claim 1, further including comparing the EIs of suppliers in the number of tiers of suppliers for the activity of the entity to identify a supplier among the number of tiers of suppliers with a threshold EI.

10. The computer-implemented method of claim 9, wherein identifying the supplier among the number of tiers of suppliers with the threshold EI includes identifying a hotspot EI in the supply chain of the entity.

11. A non-transitory computer-readable medium storing a set of instructions executable by a processing resource, wherein the set of instructions can be executed by the processing resource to:
map an output for an activity of an entity to an economic sector and an environmental sector using data accessed from a public database;
estimate a final demand output for the activity of the entity using data associated with the mapped economic sector, wherein the final demand output of the activity includes an estimate of sales to final markets;
identify a number of tiers of suppliers for the activity of the entity;
estimate an environmental impact (EI) for each supplier in each of the number of tiers of suppliers for the activity of the entity based on the final demand output for the activity and data associated with the mapped environmental sector; and
determine a tier-based EI of the number of tiers of suppliers for the activity of the entity based on the number of EIs of each supplier in each of the number of tiers of suppliers.

12. The non-transitory computer-readable medium of claim 11, wherein the set of instructions can be executed by the processing resource to create at least one of a database and a matrix using the data accessed from the public database.

13. The non-transitory computer-readable medium of claim 11, wherein the set of instructions can be executed by the processing resource to compare the EIs of suppliers in the number of tiers of suppliers to identify suppliers with a threshold EI.

14. The non-transitory computer-readable medium of claim 11, wherein the set of instructions executed by the processing resource to estimate in-house entity production of the output of the activity and outsourced production of the output of the activity.

15. A system for calculating a tier-based environmental impact (EI) of suppliers of an entity comprising:
a processing resource; and
a memory resource coupled to the processing resource and configured to direct the processing resource to:
map an output of an activity for each of a number of sub-entities of the entity to a number of economic sectors and a number of environmental sectors using data accessed from a public database;
estimate a final demand output for each activity of the number of sub-entities based on data associated with the number of mapped economic sectors, wherein the final demand output for each activity includes an estimate of sales to final markets;
estimate an EI for each supplier in each of a number of tiers of suppliers for each activity of the number of sub-entities based on the estimated final demand outputs and data associated with the number of mapped environmental sectors;
determine a tier-based EI of the number of tiers of suppliers based on the number of EIs of each supplier in each of the number of tiers of suppliers for each activity of the number of sub-entities; and
compare the EIs of suppliers in the number of tiers of suppliers for each activity of the number of sub-entities to identify suppliers with a threshold EI.

16. The system of claim 15, wherein the memory resource is configured to direct the processing resource to calculate a total EI of the entity based on the tier-based EI of the number of tiers of suppliers and a calculated EI of operations of the entity.

17. The system of claim 15, further including:
a display; and
the memory resource configured to direct the processing resource to provide an image of the determined tier-based EI of the number of tiers of suppliers on the display;
wherein the image further includes at least one of tier specific EIs by economic sector, tier specific EIs by sub-entity, and tier specific EIs by economic sector and sub-entity.

18. The system claim of 15, wherein the memory resource is configured to direct the processing resource to estimate the EI for each of the suppliers in each of the number of tiers of suppliers for each activity of the number of sub-entities by correlating supplier purchases by the number of sub-entities to a number of impacts associated with a number of environmental sectors using an environmental database.
